(19) United States
(12) Patent Application Publication
(10) Pub. No.: US 2026/0087500 A1
(43) Pub. Date: Mar. 26, 2026

(54) ARTIFICIAL INTELLIGENCE-DRIVEN SYSTEMS AND METHODS FOR AUTOMATING SARBANES-OXLEY (SOX) CONTROLS

(71) Applicant: AT&T Intellectual Property I, L.P., Atlanta, GA (US)

(72) Inventors: Preston Landell, Pace, FL (US); Mitchell Gunnels, Ball Ground, GA (US); Andrew Markus, Alpharetta, GA (US); Karthic Raghavan, Redmond, WA (US)

(73) Assignee: AT&T Intellectual Property I, L.P., Atlanta, GA (US)

(21) Appl. No.: 18/893,305

(22) Filed: Sep. 23, 2024

(51) Int. Cl. G06Q 30/018; G06F 11/36; G06Q 10/0637

(52) U.S. Cl. CPC G06Q 30/018; G06F 11/3692; G06Q 10/06375

(57) ABSTRACT

Aspects of the subject disclosure may include, for example, a device comprising: a processing system including a processor; and a memory that stores executable instructions that, when executed by the processing system, facilitate performance of operations, the operations comprising: obtaining historic data indicative of corporate governance controls that have been applied to a plurality of software applications; obtaining characterization data indicative of operating features associated with a software application under test; and inputting the historic data and the characterization data to a first generative artificial intelligence (AI) process, wherein the first generative AI process outputs one or more proposed corporate governance controls to be applied to the software application under test. Other embodiments are disclosed.

### FIELD OF THE DISCLOSURE

The subject disclosure relates to artificial intelligence-driven systems and methods for automating Sarbanes-Oxley (SOX) controls.

### BACKGROUND

The Sarbanes-Oxley Act (SOX) requires public companies to establish internal controls and procedures for financial (and other) reporting to reduce the risk of corporate fraud. However, this process is typically manual (possibly using some rule-based automation), time-consuming, prone to human error, and susceptible to external influences.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a system in accordance with various aspects described herein.

FIG. 2A depicts an illustrative embodiment of a method in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for artificial intelligence-driven systems and methods for automating Sarbanes-Oxley (SOX) controls. Other embodiments are described in the subject disclosure.

As described herein, various embodiments provide mechanisms to automate a SOX compliance process (thus being efficient, accurate, unbiased, and adaptable to different firms and industries). The automation (according to various embodiments) can include continuous (or essentially continuous) monitoring and detection, the ability to create remediation and preventive controls, and a customizable alert system for any inconsistencies and/or non-compliance detected. The automation (according to various embodiments) can: create SOX controls that can be reviewed and approved by a human team; execute a test plan to provide proof of the effectiveness of the SOX controls; and/or have the capability to report and alert on its findings in real-time.

One or more aspects of the subject disclosure include a device comprising: a processing system including a processor; and a memory that stores executable instructions that, when executed by the processing system, facilitate performance of operations, the operations comprising: obtaining historic data indicative of corporate governance controls that have been applied to a plurality of software applications; obtaining characterization data indicative of operating features associated with a software application under test; and inputting the historic data and the characterization data to a first generative artificial intelligence (AI) process, wherein the first generative AI process outputs one or more proposed corporate governance controls to be applied to the software application under test.

One or more aspects of the subject disclosure include a non-transitory machine-readable medium comprising executable instructions that, when executed by a processing system including a processor, facilitate performance of operations, the operations comprising: obtaining first information identifying one or more Sarbanes-Oxley (SOX) controls that have been applied to a deployed software program; obtaining second information identifying one or more features associated with a software program under test; inputting the first and second information to a first generative artificial intelligence (AI) process, wherein the first generative AI process outputs one or more suggested SOX controls to be applied to the software program under test; inputting the one or more suggested SOX controls to a second generative AI process, wherein the second generative AI process outputs a test plan for the software program under test, and wherein the test plan indicates how each of the one or more suggested SOX controls is to be tested relative to the software program under test; applying the test plan to the software program under test; and outputting one or more results of the applying of the test plan.

One or more aspects of the subject disclosure include a method comprising: obtaining, by a processing system including a processor, first information that characterizes development of at least one software program; obtaining, by the processing system, second information that identifies one or more Sarbanes-Oxley (SOX) controls that have been applied to the software program; obtaining, by the processing system, third information that characterizes development of a software program under test; inputting the first, second, and third information to a first generative artificial intelligence (AI) process, wherein the first generative AI process outputs one or more suggested SOX controls to be applied to the software program under test; inputting the one or more suggested SOX controls to a second generative AI process, wherein the second generative AI process outputs a recommended test plan for the software program under test, and wherein the recommended test plan indicates how each of the one or more suggested SOX controls is to be tested for the software program under test; applying the recommended test plan to the software program under test; and outputting one or more results of the applying of the test plan.

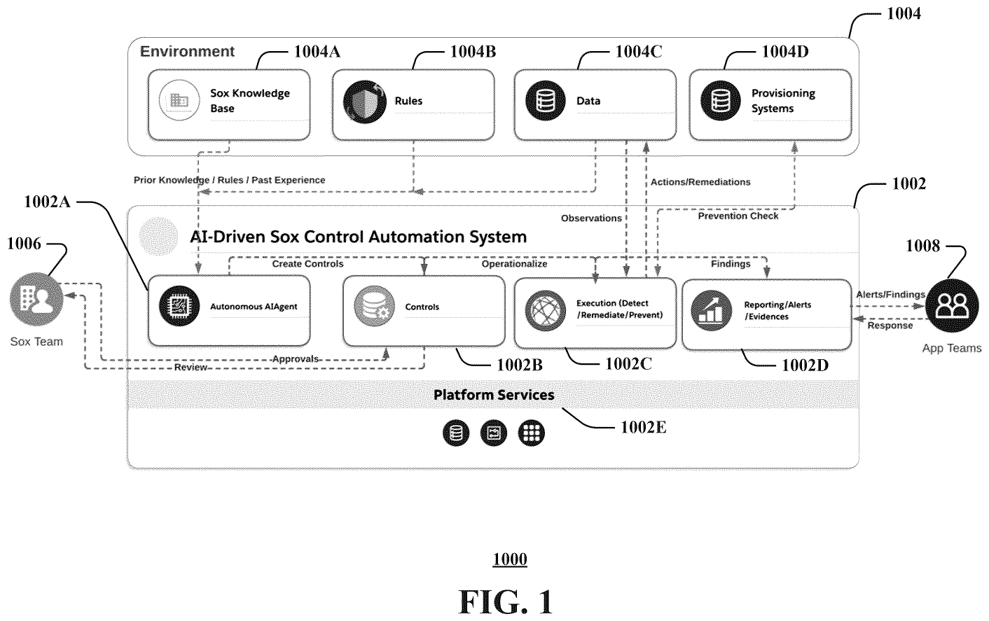

Referring now to FIG. 1, this is a block diagram illustrating an example, non-limiting embodiment of a system 1000 in accordance with various aspects described herein. As seen in this figure (which relates to an AI-driven mechanism for SOX compliance), an automation system 1002 is configured for bi-directional communications with an environment 1004. The environment 1004 comprises SOX knowledge base 1004A, rules 1004B, data 1004C, and provisioning systems 1004D. The automation system 1002 comprises autonomous AI agent 1002A, controls 1002B (the creation of which is discussed in more detail below), execution element 1002C (the operation of which is discussed in more detail below), and reporting/alerts/evidence 1002D (the content of which is discussed in more detail below). Further, automation system 1002 comprises and/or interfaces with platform services 1002E (e.g., various functional components).

Still referring to FIG. 1, operation of system 1000 can be as follows. The autonomous AI agent 1002A receives input from SOX knowledge base 1004A, rules 1004B, and data 1004C (such input can be, e.g., in the form of prior knowledge, rules, and past experience). The autonomous AI agent 1002A uses this input and implements a generative AI process to create controls (SOX controls) 1002B. Further, the autonomous AI agent 1002A uses this input to operationalize execution element 1002C (e.g., to detect/remediate/prevent). Further still, the autonomous AI agent 1002A uses this input to supply findings to reporting/alerts/evidence 1002D. Moreover, the execution element 1002C receives (along with the output from AI agent 1002A) observations from data 1004C. In addition, the execution element 1002C sends actions/remediations to data 1004C. Also, execution element 1002C sends to and receives from provisioning systems 1004D prevention check information (the provisioning systems can relate to, for example, software application provisioning systems, wireless communications provisioning systems, and/or wired communications provisioning systems).

Still referring to FIG. 1, it is seen that a SOX team 1006 (e.g., one or more auditors, managers, responsible parties, or the like) can receive controls for review and can send back approvals (or denials). Further, apps team 1008 (e.g., one or more programmers, software engineers, developers, or the like) can receive alerts/findings and can send back responses.

Referring now to an AI agent according to an embodiment (see, e.g., 1002A of FIG. 1) such an AI agent can be an autonomous entity, unaffected by other (e.g., external) agents. This AI agent can be programmed with an unbiased, objective approach to evaluate various components (e.g., user stories, test plans, code, the firm's SOX framework and/or knowledge base, etc.).

Referring now to a customizable SOX knowledge base according to an embodiment (see, e.g., 1004A of FIG. 1) such a SOX knowledge base (upon which an AI agent can base its evaluations and control generation) can allow for adaptability across different firms and industries, catering to their specific SOX compliance needs.

Referring now to SOX controls creation according to an embodiment (see, e.g., the arrow between 1002A and 1002B of FIG. 1) such SOX controls creation (which results in one or more SOX controls) can be developed with the firm's SOX framework in mind (thus ensuring an efficient and accurate control creation process). These SOX controls can include monitoring, detection, remediation, and/or preventive intelligence).

Referring now to a human approval process according to an embodiment (see, e.g., the arrows between 1006 and 1002B of FIG. 1) such human approval process can occur after the AI agent creates the SOX controls. The team can provide feedback, leading to iterations of the controls if necessary (thus ensuring that the final set of controls is thorough and appropriate).

Referring now to a SOX controls test plan according to an embodiment, subsequent to the human approval process mentioned above, a test plan for the SOX controls can be created. This test plan can outline how each control will be tested to ensure its effectiveness and reliability.

Referring now to proof of SOX controls execution according to an embodiment, the AI agent (see, e.g., 1002A of FIG. 1) can execute the test plan mentioned above, providing proof of the SOX controls'effectiveness. The AI agent can compile the results of this execution (e.g., presenting the results to a human for final approval).

Referring now to reporting and alerting according to an embodiment (see, e.g., 1002D of FIG. 1), apart from sending reports and findings along with data lineage, the system can also be designed to send real-time alerts when inconsistencies and/or non-compliance is detected during the control creation and evaluation process. The alert system can be customizable according to the firm's requirements and can be set to notify specific individuals and/or teams.

As described herein, various embodiments provide an AI-driven system/method for SOX compliance (which can comprise an automated, efficient, and reliable solution for firms to monitor and ensure SOX compliance). Various embodiments can leverage AI capabilities to evaluate various components, create and test SOX controls, and present results for human approval (all while being customizable to suit specific firm and/or industry requirements).

As described herein, various embodiments provide mechanisms to facilitate automation efficiency. For instance, an AI-driven system/method (according to various embodiments) can automate the process of SOX compliance (which traditionally is manual and time-consuming). This automation can significantly increase efficiency and productivity.

As described herein, various embodiments provide mechanisms to facilitate accuracy and reliability. For instance, with an AI agent at its core, a system/method (according to various embodiments) can significantly reduce the risk of human error (thus making the evaluation, creation, and testing of SOX controls more accurate and reliable).

As described herein, various embodiments provide mechanisms to facilitate unbiased evaluation. For instance, an AI agent (according to various embodiments) is unaffected by external influences (thus ensuring an unbiased, objective approach to SOX compliance).

As described herein, various embodiments provide mechanisms to facilitate a customizable SOX knowledge base (thus allowing for adaptability across different firms and industries—this caters to their specific SOX compliance needs).

As described herein, various embodiments provide mechanisms to facilitate comprehensive controls creation. For instance, an AI agent (according to various embodiments) can create a comprehensive set of SOX controls (including monitoring, detection, remediation, and preventive intelligence). This can ensure that all aspects required for completeness are covered.

As described herein, various embodiments provide mechanisms to facilitate a human approval process (thus ensuring that the final set of controls is thorough and appropriate).

As described herein, various embodiments provide mechanisms to facilitate real-time alerting. For instance, a system/method (according to various embodiments) can send real-time alerts when inconsistencies and/or non-compliance is detected (thus enabling quick response and action).

As described herein, various embodiments provide mechanisms to facilitate comprehensive reporting of findings (thus further enhancing transparency and accountability in the SOX compliance process).

As described herein, various embodiments provide mechanisms to facilitate scalability. For instance, given its AI-driven nature, a system/method (according to various embodiments) can be scaled across large organizations with multiple departments (thus ensuring organization-wide compliance with SOX controls).

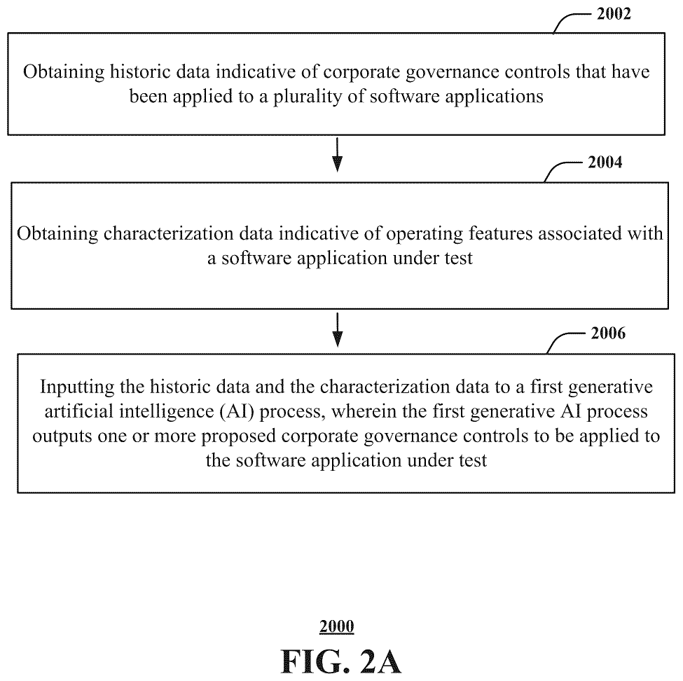

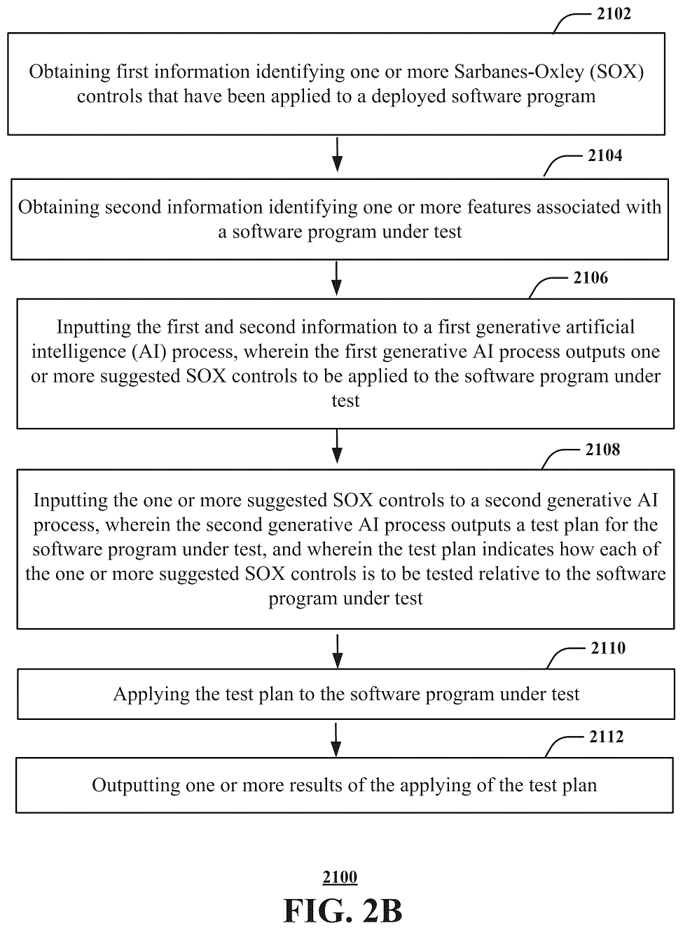

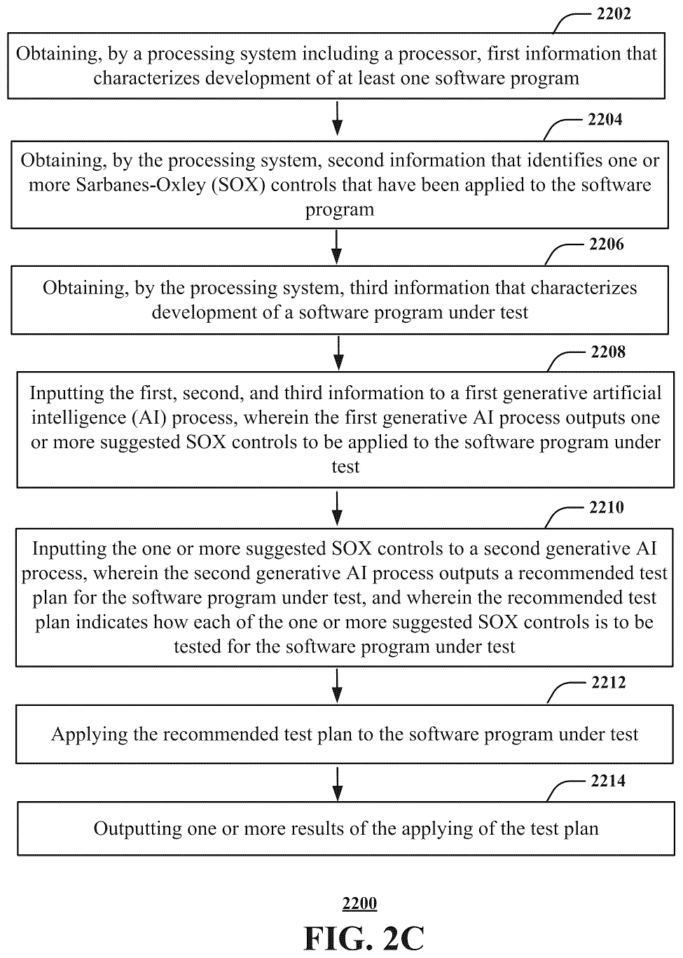

Referring now to FIG. 2A, various steps of a method 2000 according to an embodiment are shown. As seen in this FIG. 2A, step 2002 comprises obtaining historic data indicative of corporate governance controls that have been applied to a plurality of software applications. Next, step 2004 comprises obtaining characterization data indicative of operating features associated with a software application under test. Next, step 2006 comprises inputting the historic data and the characterization data to a first generative artificial intelligence (AI) process, wherein the first generative AI process outputs one or more proposed corporate governance controls to be applied to the software application under test.

While for purposes of simplicity of explanation, the respective processes are shown and described as a series of blocks in FIG. 2A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2B, various steps of a method 2100 according to an embodiment are shown. As seen in this FIG. 2B, step 2102 comprises obtaining first information identifying one or more Sarbanes-Oxley (SOX) controls that have been applied to a deployed software program. Next, step 2104 comprises obtaining second information identifying one or more features associated with a software program under test. Next, step 2106 comprises inputting the first and second information to a first generative artificial intelligence (AI) process, wherein the first generative AI process outputs one or more suggested SOX controls to be applied to the software program under test. Next, step 2108 comprises inputting the one or more suggested SOX controls to a second generative AI process, wherein the second generative AI process outputs a test plan for the software program under test, and wherein the test plan indicates how each of the one or more suggested SOX controls is to be tested relative to the software program under test. Next, step 2110 comprises applying the test plan to the software program under test. Next, step 2112 outputting one or more results of the applying of the test plan.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2C, various steps of a method 2200 according to an embodiment are shown. As seen in this FIG. 2C, step 2202 comprises obtaining, by a processing system including a processor, first information that characterizes development of at least one software program. Next, step 2204 comprises obtaining, by the processing system, second information that identifies one or more Sarbanes-Oxley (SOX) controls that have been applied to the software program. Next, step 2206 comprises obtaining, by the processing system, third information that characterizes development of a software program under test. Next, step 2208 comprises inputting the first, second, and third information to a first generative artificial intelligence (AI) process, wherein the first generative AI process outputs one or more suggested SOX controls to be applied to the software program under test. Next, step 2210 comprises inputting the one or more suggested SOX controls to a second generative AI process, wherein the second generative AI process outputs a recommended test plan for the software program under test, and wherein the recommended test plan indicates how each of the one or more suggested SOX controls is to be tested for the software program under test. Next, step 2212 comprises applying the recommended test plan to the software program under test. Next, step 2214 comprises outputting one or more results of the applying of the test plan.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments provide an artificial intelligence-driven mechanism for automating Sarbanes-Oxley (SOX) controls.

As described herein, various embodiments provide a system and a method for implementing SOX controls using an artificial intelligence (AI) agent (such an AI agent can be unaffected by external influences, and can facilitate both reactive and preventive measures in ensuring corporate compliance).

As described herein, various embodiments can be applied to software that falls within scope of required SOX compliance (e.g., sensitive applications subject to external auditing).

As described herein, various embodiments can facilitate SOX control creation related to preventing audit findings (e.g. adverse audit findings) from occurring while also proactively detecting possible findings. In various examples, such SOX controls can relate to: (a) Segregation of duties (e.g., ensuring that a single person does not have control over the core development as well as the runtime during deployment); (b) Change control management (e.g., monitor the systems in which the applications are deployed and look at the application files and make sure that nobody is making any unauthorized changes); (c) Code management (e.g., every code merged to the main branch should be peer reviewed); or (d) any combination thereof.

As described herein, various embodiments can facilitate SOX control creation related to controls across the software lifecycle phases. In various examples, such controls can relate to (e.g., implement and/or be facilitated by): (a) Automated continuous detection system with AI generated remediations and preventive intelligence to deny improper user access provisioning and prevent SOX findings (e.g., adverse findings); (b) AI-assisted detection system that identifies Configuration Management violations, such as code merges without peer review, code commits without approved features or user stories, code committed without unit tests, and detecting security vulnerabilities in the code; (c) AI-enabled evaluation system implemented pipelines (such evaluation system can review promotions from lower environments, require a separate build and release pipeline, require two-person approval for production deployments, capture change requests (CRs) for production releases, review builds against the main branch, and create gates to capture test results); (d) AI-assisted detection to monitor pipeline executions from centralized logs, ensuring adherence to pipeline definitions by only allowing production rollouts during approved Change Request (CR) windows, and verifying that deployed code corresponds to approved user stories or Change Requests; (e) Independent agents that monitor file integrity on production servers and environments, coupled with advanced data lineage alerting triggered by violations; or (f) any combination thereof.

As described herein, various embodiments can facilitate SOX control creation related to: (a) Using AskData functionality to review system logs and data stores to ensure source to target reconciliation; (b) Production of square package allowing auditors to document their findings more effectively and faster; (c) Automated testing and validation of controls; (d) Predictive forecasting of future control weakness or failure; or (e) any combination thereof.

As described herein, various embodiments can provide a historical database containing SOX-related information. Such SOX-related information can comprise historical findings from prior SOX audits made by external auditors (e.g., outlining what was done right and what was not done right based upon rules/laws).

As described herein, various embodiments can be applied to SOX control creation covering user access violations and/or control access violations.

As described herein, various embodiments can be applied to SOX control creation via generative AI using large language models (LLMs).

As described herein, various embodiments can be used by any publicly traded company that is mandated to remain in compliance with SOX.

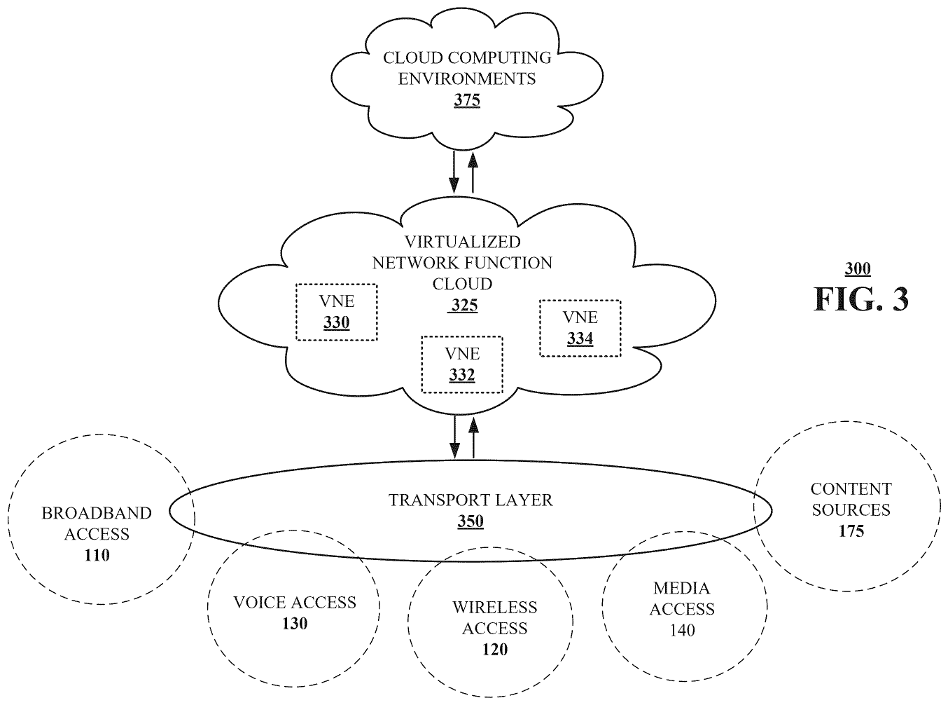

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 1000, and/or some or all of the functions of methods 2000, 2100, 2200. For example, virtualized communication network 300 can facilitate in whole or in part artificial intelligence-driven systems and methods for automating SOX controls.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element, such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

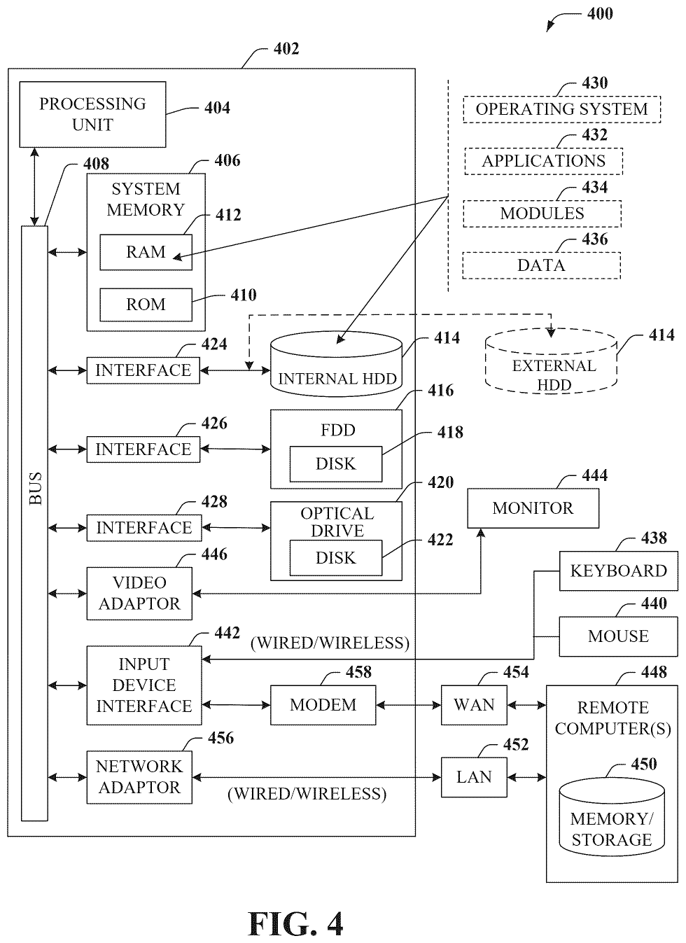

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements, access terminal, base station or access point, switching device, media terminal, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part artificial intelligence-driven systems and methods for automating SOX controls.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

As described herein, various embodiments employ artificial intelligence (AI) to facilitate automating one or more features described herein. The embodiments (e.g., in connection with automating SOX control creation) can employ various AI-based schemes for carrying out various embodiments thereof. Moreover, a classifier can be employed to determine a ranking or priority of each software program, software application, and/or SOX control. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed.

Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which software program(s), software application(s), and/or SOX control(s) is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining historic data indicative of corporate governance controls that have been applied to a plurality of software applications;
obtaining characterization data indicative of operating features associated with a software application under test; and
inputting the historic data and the characterization data to a first generative artificial intelligence (AI) process, wherein the first generative AI process outputs one or more proposed corporate governance controls to be applied to the software application under test.

2. The device of claim 1, wherein the operations further comprise:
inputting the one or more proposed corporate governance controls to a second generative AI process, wherein the second generative AI process outputs a test plan for the software application under test.

3. The device of claim 2, wherein:
the test plan indicates how each of the one or more proposed corporate governance controls is to be tested.

4. The device of claim 3, wherein the operations further comprise:
applying the test plan to the software application under test; and
outputting one or more results of the applying of the test plan.

5. The device of claim 4, wherein the outputting comprises:
outputting one or more real-time alerts.

6. The device of claim 1, wherein each of the corporate governance controls and the proposed corporate governance controls comprises a respective Sarbanes-Oxley (SOX) control.

7. The device of claim 1, wherein:
each of the plurality of software applications comprises a respective source code, a respective runtime code; or a respective combination thereof; and
the software application under test comprises a source code under test, a runtime code under test; or a combination thereof.

8. The device of claim 7, wherein:
at least one of the corporate governance controls relates to each respective source code; and
the one or more proposed corporate governance controls relate to the source code under test.

9. The device of claim 7, wherein:
at least one of the corporate governance controls relates to each respective runtime code; and
the one or more proposed corporate governance controls relate to the runtime code under test.

10. The device of claim 1, wherein:
each of the corporate governance controls relates to access control, change, control, release control, distribution control, deployment, or any combination thereof; and
each of the one or more proposed corporate governance controls relates to access control, change, control, release control, distribution control, deployment, or any combination thereof.

11. The device of claim 1, wherein:
each of the corporate governance controls relates to monitoring, detection, remediation, prevention, or any combination thereof; and
each of the one or more proposed corporate governance controls relates to monitoring, detection, remediation, prevention, or any combination thereof.

12. The device of claim 1, wherein each of the plurality of software applications and the software application under test comprises a respective communications network software application.

13. The device of claim 12, wherein each communications network software application comprises a respective wireless communications network software application.

14. The device of claim 13, wherein the operating features facilitate operation of a wireless communications network.

15. The device of claim 1, wherein:
the first generative AI process comprises a machine leaning (ML) process.

16. A non-transitory machine-readable medium comprising executable instructions that, when executed by a processing system including a processor, facilitate performance of operations, the operations comprising:
obtaining first information identifying one or more Sarbanes-Oxley (SOX) controls that have been applied to a deployed software program;
obtaining second information identifying one or more features associated with a software program under test;
inputting the first and second information to a first generative artificial intelligence (AI) process, wherein the first generative AI process outputs one or more suggested SOX controls to be applied to the software program under test;
inputting the one or more suggested SOX controls to a second generative AI process, wherein the second generative AI process outputs a test plan for the software program under test, and wherein the test plan indicates how each of the one or more suggested SOX controls is to be tested relative to the software program under test;
applying the test plan to the software program under test; and
outputting one or more results of the applying of the test plan.

17. The non-transitory machine-readable medium of claim 16, wherein:
the software program under test comprises source code, runtime code, or a combination thereof.

18. The non-transitory machine-readable medium of claim 17, wherein:
each of the one or more suggested SOX controls provides for monitoring, detection, remediation, prevention, or any combination thereof.

19. A method comprising:
obtaining, by a processing system including a processor, first information that characterizes development of at least one software program;
obtaining, by the processing system, second information that identifies one or more Sarbanes-Oxley (SOX) controls that have been applied to the software program;
obtaining, by the processing system, third information that characterizes development of a software program under test;
inputting the first, second, and third information to a first generative artificial intelligence (AI) process, wherein the first generative AI process outputs one or more suggested SOX controls to be applied to the software program under test;
inputting the one or more suggested SOX controls to a second generative AI process, wherein the second generative AI process outputs a recommended test plan for the software program under test, and wherein the recommended test plan indicates how each of the one or more suggested SOX controls is to be tested for the software program under test;
applying the recommended test plan to the software program under test; and
outputting one or more results of the applying of the test plan.

20. The method of claim 19, wherein:
the first information comprises one or more user stories, one or more test plans, one or more test plan results, source code of the software program, runtime code of the software program, or any combination thereof;
each of the one or more SOX controls of the second information provides for monitoring, detection, remediation, prevention, or any combination thereof;
the third information comprises one or more user stories, one or more test plans, one or more test plan results, source code of the software program under test, runtime code of the software program under test, or any combination thereof; and
each of the one or more suggested SOX controls provides for monitoring, detection, remediation, prevention, or any combination thereof.
